(19) United States
(12) Patent Application Publication
(10) Pub. No.: US 2026/0270784 A1
(43) Pub. Date: Sep. 10, 2026

(54) Hardware Acceleration for Fragment Reassembly and Checksums

(71) Applicant: Marvell Asia Pte Ltd, Singapore (SG)

(72) Inventors: Patrick Clobridge, Brighton, MA (US); Steven C. Barner, Shrewsbury, MA (US)

(21) Appl. No.: 19/562,564

(22) Filed: Mar. 10, 2026

Related U.S. Application Data
(60) Provisional application No. 63/769,653, filed on Mar. 10, 2025.

(51) Int. Cl. H04W 28/06; H04L 9/32

(52) U.S. Cl. CPC H04W 28/065; H04L 9/3236

(57) ABSTRACT

A method of reassembling a set of packet fragments comprises receiving, with a hardware-based input processing handler, a plurality of packet fragments, and associating, with a hardware-based hash content addressable memory (CAM), two or more of the plurality of packet fragments as components of a complete packet. The method further comprises excising, with a hardware-based reassembly engine, one or more headers from the two or more of the plurality of packet fragments to produce excised packet fragments, and combining, with the hardware-based reassembly engine, the excised packet fragments to form a reassembled complete packet. The method may further comprise determining a partial checksum for each packet fragment payload and storing the partial checksum in memory. The method may further comprise combining the partial checksums determined for each packet fragment payload to form a complete checksum that is appended to the complete packet payload.

### RELATED APPLICATION

This application claims the benefit of U.S. Provisional Application No. 63/769,653, filed on March 10, 2025. The entire teachings of the above application are incorporated herein by reference.

### BACKGROUND

IPv4 and IPv6 reassembly refers to the process of reconstructing fragmented packets at the network destination node. IPv4 and IPv6 reassembly are tasks traditionally performed by software (e.g., in the LINUX stack).

Reassembly in software, however, is a tedious task, especially within the inline path of a Data Processing Unit. After performing decryption on a packet and discovering the packet is a fragment, the decrypted packet is sent to a Central Processing Unit (CPU) core to perform the reassembly task, then the reassembled packet is sent back into the inline flow. This reassembly flow adds more strain to the workload of a CPU core, thereby preventing allocation of other essential processes.

### SUMMARY

The embodiments described herein are directed to a hardware-based accelerator that performs Internet Protocol (IP) fragment association and packet reassembly. The packet reassembly is accomplished by stitching together payloads of the fragment into one seamless packet. The reassembled packets may be represented as a list of pointers with irrelevant fragment information removed. In addition, described embodiments may perform incremental check-summing for Transmission Control Protocol (TCP)/User Datagram Protocol (UDP)/Stream Control Transmission Protocol (SCTP) packets and calculating the final packet checksum from the checksums of its constituent fragments.

An example embodiment may perform IP fragment association on up to eight fragments per packet association.

Diverting repetitive tasks from Central Processing Unit (CPU) cores frees up bandwidth to increase throughput performance. Reading an entire fragment into a CPU (up to about 9KB of data), as is needed to perform a checksum, uses substantial memory and bus bandwidth. Placing the hardware accelerator of the described embodiments on a dedicated inline path in silicon reduces latency by not needing to communicate across the chip to send packet data from the Cryptographic Engine to the CPU mesh and back. This hardware accelerator also consumes less power and only needs to read the Layer 2/Layer 3 portion of the packet and 32 bits of checksum per fragment.

In one aspect, the invention may be a method of reassembling a set of packet fragments, comprising receiving, with a hardware-based input processing handler, a plurality of packet fragments, and associating, with a hardware-based hash content addressable memory (CAM), two or more of the plurality of packet fragments as components of a complete packet. The method may further comprise excising, with a hardware-based reassembly engine, one or more headers from the two or more of the plurality of packet fragments to produce excised packet fragments, and combining, with the hardware-based reassembly engine, the excised packet fragments to form a reassembled complete packet.

The associating may further comprise generating a current hash of one or more components of a packet fragment header and determining that a prior generated hash matches the current hash. The method may further comprise storing headers of the plurality of packet fragments and first fragment of the complete packet in a hardware-based header storage component. The method may further comprise determining a partial checksum for each packet fragment payload and storing the partial checksum in memory. The method may further comprise combining the partial checksums determined for each packet fragment payload to form a complete checksum that is appended to the complete packet payload.

The method may further comprise forwarding to a software-based processing system, using a hardware-based metapacket formatter, two or more pointers to components of the complete packet.

In another aspect, the invention may be a system for reassembling a set of packet fragments, comprising a hardware-based input processing handler that receives a plurality of packet fragments, and a hardware-based hash content addressable memory (CAM) that associates two or more of the plurality of packet fragments as components of a complete packet. The system may further comprise a hardware-based reassembly engine that excises one or more headers from the two or more of the plurality of packet fragments to produce excised packet fragments. The hardware-based reassembly engine may combine the excised packet fragments to form a reassembled complete packet.

The hardware-based hash CAM may further generate a current hash of one or more components of a packet fragment header, and determine that a prior generated hash matches the current hash. The system may further comprise a hardware-based header storage component that stores headers of the plurality of packet fragments and first fragment of the complete packet. A partial checksum for each packet fragment payload may be stored in memory. A fragment association state component may combine the partial checksums determined for each packet fragment payload to form a complete checksum that is appended to the complete packet payload.

A hardware-based metapacket formatter may forward two or more pointers to a software-based processing system. Each of the two or more pointers may designate a component of the complete packet. The hardware-based hash CAM may generate and store a CRC checksum for each stored key and searches the stored CRC checksums to determine if the CRC of an incoming key matches any of the stored CRC checksums. The reassembly engine may further stitch together two or more pointers across packet fragments into a single list of scatter-gather blocks.

In another aspect, the invention may be a non-transitory computer-readable medium with computer code instruction stored thereon. The computer code instructions, when executed by a processor, may cause an apparatus to receive a plurality of packet fragments, associate two or more of the plurality of packet fragments as components of a complete packet, excise one or more headers from the two or more of the plurality of packet fragments to produce excised packet fragments, and combine the excised packet fragments to form a reassembled complete packet.

The computer code instructions may further cause an apparatus to generate a current hash of one or more components of a packet fragment header and determines that a prior generated hash matches the current hash. The computer code instructions may further cause an apparatus to store headers of the plurality of packet fragments and first fragment of the complete packet. The computer code instructions may further cause an apparatus to store a partial checksum for each packet in memory. The computer code instructions may further cause an apparatus to combine the partial checksums determined for each packet fragment payload to form a complete checksum that is appended to the complete packet payload.

In another aspect, the invention may be a system for reassembling a set of packet fragments, comprising means for receiving a plurality of packet fragments, means for associating two or more of the plurality of packet fragments as components of a complete packet, means for excising one or more headers from the two or more of the plurality of packet fragments to produce excised packet fragments, and means for combining the excised packet fragments to form a reassembled complete packet.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 shows an example embodiment of a network packet processor.

FIG. 2 shows an expansion of the Reassembly Accelerator from FIG. 1.

FIG. 3 illustrates details of the Input Processing Handler according to an embodiment.

FIG. 4 shows details of the Hash CAM as described with respect to FIG. 2, according to an embodiment.

FIG. 5 shows the data format of the reassembly output from the Metapacket Formatter, according to an embodiment.

FIG. 6 shows the data structure of the reclassification output according to an embodiment.

FIG. 7 shows a diagram of an example internal structure of a processing system according to an embodiment.

### DETAILED DESCRIPTION

A description of example embodiments follows.

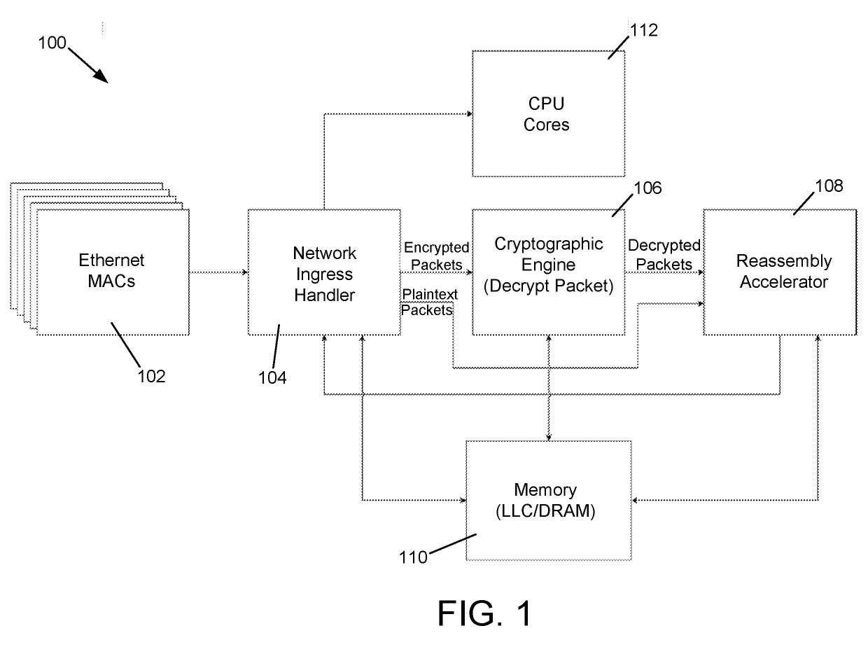

FIG. 1 shows an example embodiment of a network packet processor 100, which includes Media Access Controllers (MACs) 102, a network ingress module 104, a cryptographic engine 106, a reassembly accelerator 108, memory 110, and CPU cores 112. The embodiments described herein are primarily directed to the reassembly accelerator 108, although aspects of the described embodiments may be implemented within part of one or more other components of the network packet processor 100.

An Ethernet MAC 102 initially receives a packet entering the network packet processor 100, followed by the Network Ingress Handler 104. The Network Ingress Handler 104 includes a classifier that parses the incoming packet and determines what kind of packet it is. Among other rules-based actions, the Network Ingress Handler 104 determines if the incoming packet is an Internet Protocol security (IPsec) packet, which, for example, is encrypted as part of a VPN. If the incoming packet is determined to be an IPsec packet, the Network Ingress Handler 104 passes the packet to the Cryptographic Engine 106, which decrypts and decapsulates the packet. This results in an inner IP, which may be identified as a fragment. When the inner IP is identified as a fragment, the Cryptographic Engine 106 forwards the inner IP to the Reassembly Accelerator 108, which will enter the fragment into the fragment table.

As depicted in FIG. 1, the Reassembly Accelerator 108 receives decrypted packets from the Cryptographic Engine 106 and/or plaintext packets directly from the Network Ingress Handler 104. In the example embodiment, both encrypted and plaintext go through the cryptographic engine 106. Receiving both encrypted and plaintext packets demonstrates that packet fragments may be reassembled even if they are not encrypted.

In some cases, packets are received that look like regular packets, where it is not yet known whether the packet is encrypted or not. The fragments need to be reassembled to determine if packet is an IPsec packet. Once reassembled, the packet goes through the Network Ingress Handler 104 where the network classifier determines that the packet is an IPsec packet and forwards the IPsec packet to the Cryptographic Engine 106.

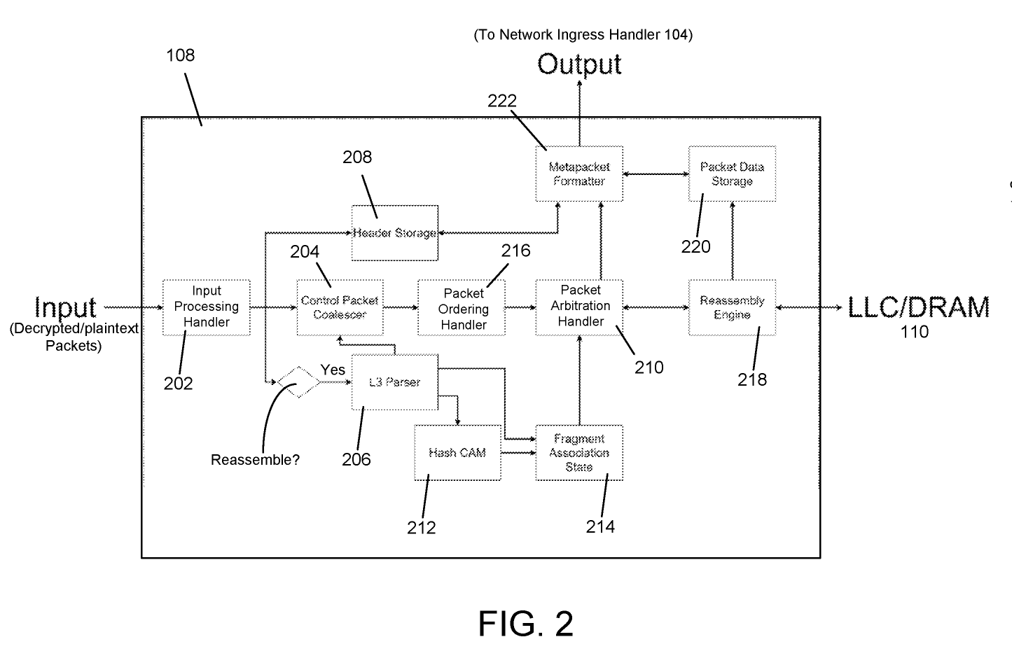

FIG. 2 shows an expansion of the Reassembly Accelerator 108 from FIG. 1. An Input Processing Handler 202 receives decrypted packets and plaintext packets from the Cryptographic Engine 106. Input Processing Handler 202 distributes the received information to the Control Packet Coalescer 204, Header Storage 208, and, if reassembly is necessary, to the L3 Parser 206. Multiple streams of data come through from both the Network Ingress Handler 104 and Cryptographic Engine 106. This data is arbitrated and is sent to either the Control Packet Coalescer 204, Header Storage 208, or the L3 Parser 206. This input data is a mixture of control and data packets that keeps track of the current packet in the previous stages inside of Network Ingress 104 and Cryptographic Engine 106. The control data and the packet data are sent in on different buses.

The Control Packet Coalescer 204 manages organizing inputs to be suitable for other components of the Reassembly Accelerator 108. Each packet has been given an ID, and the current input status of the packet is kept in the Control Packet Coalescer 204. The packets sent into the Control Packet Coalescer 204 contains data necessary to maintain order amongst packets and to pass through for blocks down the line.

In some cases, the input is a complete packet that does not require reassembly. If, however, a fragment packet is received where reassembly is required, the L3 Parser 206 goes through the packet and parses the level 3 (L3) data, i.e., it parses out the IPv4 or IPv6 header. Fragment information data needs to be parsed out of IP headers in the packet. The first data packet for a given packet ID is sent into the L3 Parser to parse out the More Fragment bit, the fragment offset, the fragment size, and calculates the offset to the L4 payload from the start of the packet. Additional data including the source IP, Destination IP, and fragment ID are also fetched from the packet, along with any additional data provided to prevent fragment association aliasing. If the packet couldn't be parsed properly or is determined to not be a fragment, state is updated in the Control Packet Coalescer. Source IP, Destination IP, fragment ID and additional data are formed into a key and are sent to the Hash CAM 212. Other data is passed through the parser, such as the L4 checksum, and is sent to the Fragment Association State 214.

Header Storage 208 is where the IPv4 or IPv6 headers and the first fragments of a given packet are stored. That would be the header used for the packet post-reassembly. Important Metadata and the first portion of the packet are stored in Header Storage 208 to be sent back to Network Ingress Handler 104 for proper packet classification after reassembly. Each fragment that is sent in is stored in Header Storage.

The reassembly accelerator is primarily concerned with packet headers. The contents (payload) of the packet go to LLC DRAM 110, so the packet contents reside in the memory subsystem. Pointers to the contents are available so that reassembly can be done in terms of pointers to the payload rather than the payload itself.

As shown in FIG. 2, there are two paths to the Packet Arbitration Handler 210 – one from the left and one from the bottom. For the bottom path, a packet passes through the L3 Parser 206, through the Hash Content Addressable Memory (CAM) 212, and through the Fragment Association State block 214. The Hash CAM 212 generates a hash of certain components found inside of the header (e.g., source address, destination address, fragment offset, et al.), and other data components that may be used to uniquely determine if the fragment is associated with other received fragments.

For example, if two fragments are parts of a packet (i.e., they are associated), the Hash CAM 212 may be used to confirm that those fragments have the same common elements that create the association, and that they don’t alias on to some other fragment that may be part of some other unrelated packet. The Hash CAM 212 provides a way to keep track of which fragments have been seen before and if a fragment associates with another fragment that was later stored in the Fragment Association State 214. The Fragment Association State 214 stores all the information needed to understand how the fragments are being associated. This information may be used to determine that all the fragments needed to properly reassemble the packet have been gathered, and then upon that determination go forward and reassemble the packet. If there are any holes or gaps in the packet (i.e., fragments missing), or any kind of unusual error case, the Fragment Association State 214 keeps track of that information. The key provided from the L3 Parser is generated into a hash via a CRC32 algorithm. In the example embodiment, the Hash CAM 212 can store up to 8192 keys and has an accessible CAM that stores up to 11 pointers per hash value. Generated hashes are used to perform a quick lookup on keys to compare for exactness and to see if an incoming fragment matches with other fragments already stored in the Fragment Association State. In the case that an incoming key hits a hash value with 11 pointers, the oldest key is evicted from the CAM and subsequently removed from the key memory and the Fragment Association State.

The More Fragment bit, fragment offset, fragment size, and other information including the L4 checksum and L4 payload offset are sent to the Fragment Association State 214. This information is indexed based on the address its Key is stored in the Hash CAM.

The Fragment Association State 214 handles processing this fragment information to determine if all fragments have been found. Once all fragments have been found, or if an error has been found while combining the fragment information together, the Fragment Association State 214 sends the association completion information to Packet Arbitration Handler 210. Packets that reach Packet Arbitration 210 are processed in the Reassembly Engine 218 and are sent to the Metapacket Formatter 222. Packets are ordered based on the queue in which they are stored. Packet Arbitration 210 chooses which queue gets sent to Reassembly Engine 218 based on queue priority and resources available in Packet Data Storage 220. When the packet returns from Reassembly Engine 218, it is ready to be sent to the Metapacket Formatter 222. Packet Arbitration 210 chooses which queue gets sent to Metapacket Formatter 222 based on the queue priority.

While combining fragments, the Fragment Association State 214 also combines the checksums. There is support for One's Complement and CRC32C incremental check-summing. Per association state, there is state to keep the current checksum result. When the fragment association is ejected from the Fragment Association State 214, the checksum is sent along with it.

Inside of the Fragment Association State 214, there is logic to keep track of how many associations are currently active per queue and maintain the current age of each association. If a list of associations per queue grows beyond a given CSR-defined size, or if an association is older than a given CSR-defined age, the association is ejected from the Fragment Association State.

In other failure cases, we might want to keep the association in the Fragment Association State 214 to send off to Network Ingress 104. This is useful when the number of fragments in an association is greater than what can be held in the Fragment Association State 214. The fragment is sent off by itself to later be caught by Network Ingress 104 to be combined with the rest of its association.

Packets are continuously arriving on different streams and from different queues. The Packet Ordering Handler 216 ensures order is maintained among those queues. As described herein, the Packet Arbitration Handler 210 receives packets from the Packet Ordering Handler 216 and/or from the Fragment Association State 214. Once the packet has been completely sent from Network Ingress Handler 104 or the Cryptographic Engine 106, the packet is sent to Packet Ordering Handler 216 to maintain complete ordering amongst packets in the system. Packets are stored into a FIFO and are then popped off the FIFO from Packet Arbitration Handler 210 for further ordering considerations based on a given queue (in the example embodiment, there are 16 queues).

Reassembly Engine 218 deals with stitching together pointers across fragments into a single list of scatter-gather blocks. Pointers can either point directly to the packet or point to a location in LLC/DRAM that contains a list of pointers each pointing to a buffer the packet is contained in. Reassembly Engine 218 works on multiple contexts allowing for higher throughput when waiting for data to come back from LLC/DRAM. Reassembly Engine 218 stores data in Packet Data Storage 220 to be processed by Meta Packet Formatter 218. Data processed in the Fragment Association State 214, the More Fragment bit, offset, and fragment size fields of each fragment, and a list of coalesced pointers with their sizes are all stored in Packet Data Storage. In the case where pointers are direct, they are formatted and condensed into a scatter-gather block and sent off to Packet Data Storage 220. In the case where a pointer is indirect, a request to that pointer is made to LLC/DRAM with the number of blocks stored at that address. Reassembly Engine 218 waits until the data comes back and begins condensing the fetched pointers into one packed scatter-gather block. No empty slots are allowed in the scatter gather block unless it is the last scatter gather block in the chain. Pointer sizes are also shrunk to trim off L2/L3 data in non-first fragments to represent the entire L4 payload in the final result. In the case of IPv6, the first fragment has the fragment extension header trimmed off, so the size is updated to remove 8B from the total size. The total size of the resultant packet is also calculated and stored in Packet Data Storage 220, along with the number of fragments in the association, and the status of the association post reassembly. Upon reassembly completion, Reassembly Engine 218 sends a response back to Packet Arbitration 210 providing an ID required for Packet Data Storage and any credits freed up in Packet Data Storage 220 while condensing pointers into a list of scatter-gather blocks.

Once a complete set of associated fragments have been gathered, Packet Arbitration Handler 210 sends a request to the Reassembly Engine 218. In response, the Reassembly Engine 218 gets the associated pointers for each fragment and then goes to LCC/DRAM Memory 110 in order to get blocks of scatter-gather pointers, which contain the pointers to the data that makes up the actual packet payload. Reassembly Engine 218 evaluates and modifies the scatter-gather blocks so that they are properly formatted to identify all the data that is needed to make up the packet payload. The Reassembly Engine 218 eliminates any additional headers that are no longer relevant for fragments that are not at the front of the packet, and performs any other modifications to truncate the size, or to advance any pointers to properly represent the reassembled packet.

Intermediate data processed by the Reassembly Engine 218 is stored in Packet Data Storage 220. Packet Data Storage 220 is split up into a number of contexts that manage a head-tail list of blocks in SRAMs that are managed for each packet assigned to it. The number of blocks required for each packet are precalculated in Packet Arbitration 210. Packet Data Storage 220 fetches a new block of data whenever the Reassembly Engine 218 needs a new block. When Meta Packet Formatter 222 requests to read data out from Packet Data Storage 220, data is sent out in a continuous stream. After blocks are read from, credits are returned back to Packet Arbitration 210.

When a packet is ready to be sent out to Network Ingress 104, it is sent from Packet Arbitration 210 to Metapacket Formatter 222. Data provided from Packet Arbitration 210 is used to help Metapacket Formatter 222 fetch data from both Header Storage 208 and Packet Data Storage 220. The First 256B of data is fetched from Header Storage 208 and all data is fetched from Packet Data Storage 220. Data from Packet Data Storage 220 is used to override fields in the Metapacket Header. After all data is fetched from Header Storage 208, the fragment information and scatter gather blocks are appended to the meta packet. When the packet is completely formed, it is popped off from an internal FIFO and sent out to Network Ingress 104. Pointers used in Header Storage 208 and Packet Data Storage 220 are freed up.

Once the scatter/gather blocks have been reformatted, they are stored in the Packet Data Storage 220. When the Reassembly Engine 218 is done reassembling the fragmented packet the Reassembly Engine 218 sends the reassembled packet back to the Packet Arbitration Handler 210, which sends a request to the Metapacket Formatter 222 to generate an output to send to the Network Ingress Handler 104. The Metapacket Formatter 222 acquires the necessary metapacket information from the Header Storage 208, including the L2 data and L3 data.

The Packet Data Storage 220 appends the necessary fragment information at the end of the L2/L3 data, to produce a fragment information block that describes relevant information for each fragment such as its fragment offset, fragment size, whether it has a More Fragment bit or not, etc. The L2/L3 data and the appended fragment information is sent out through the Metapacket Formatter 222 to the Network Ingress Handler 104. The Reassembly Accelerator 108 determines partial CRC checksums for each of the fragments as the fragment arrives. The partial checksums are then combined by the Reassembly Accelerator to form a complete CRC checksum for the reassembled packet. By doing so, the entire reassembled packet does not need to be run through a CRC generator circuit to produce the complete checksum, which saves a substantial amount of time.

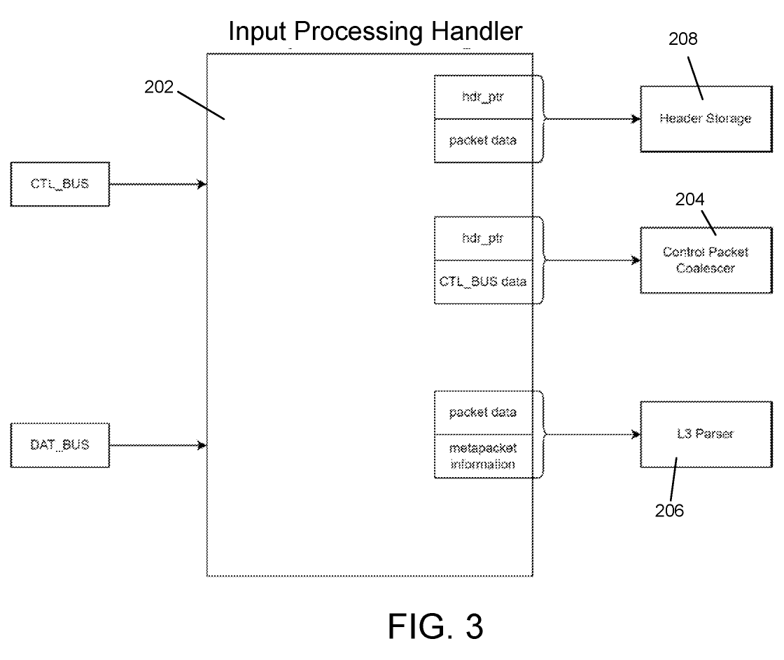

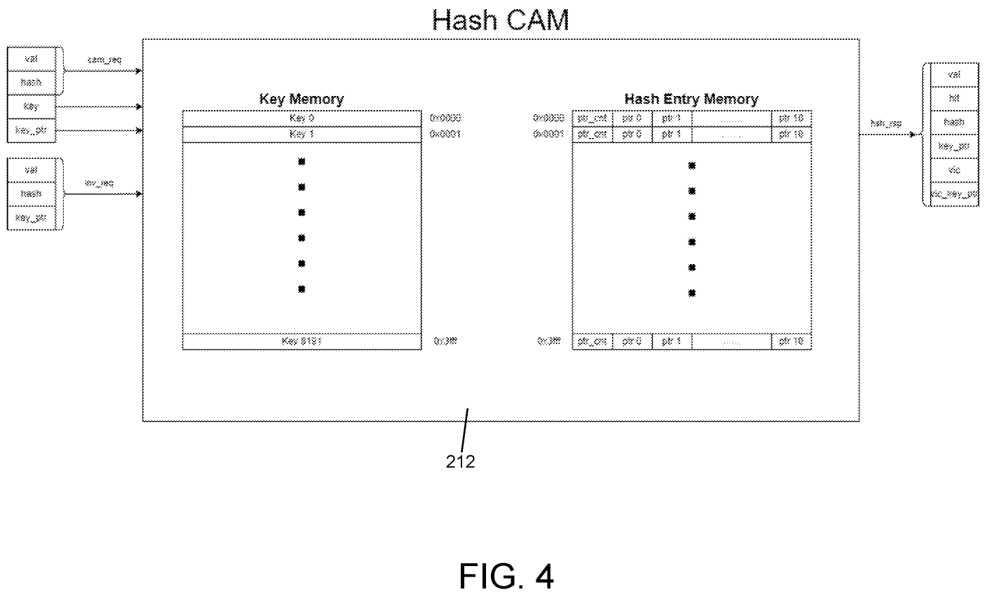

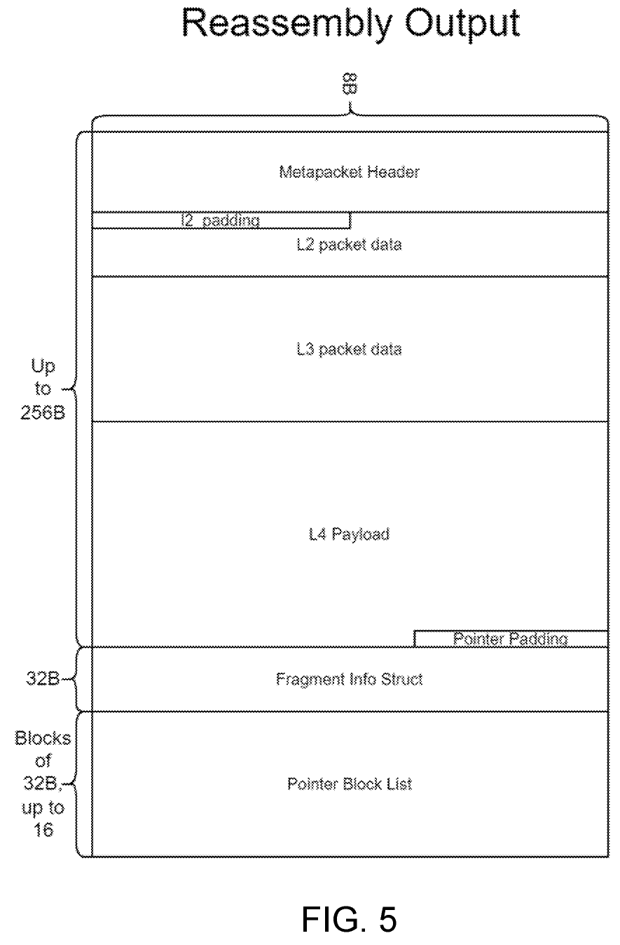

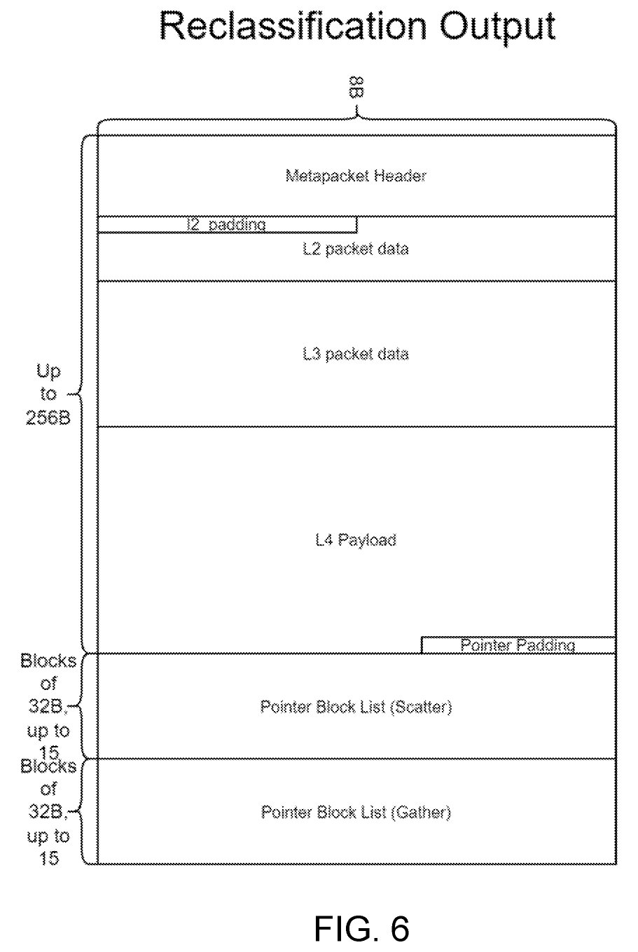

FIG. 3 illustrates details of the Input Processing Handler 202. FIG. 4 shows details of the Hash CAM 212 as described with respect to FIG. 2. FIG. 5 shows the data structure of the reassembly output from the Metapacket Formatter 222 shown in FIG. 2. FIG. 6 shows the data structure of the reclassification output with pointer block lists for scatter/gather.

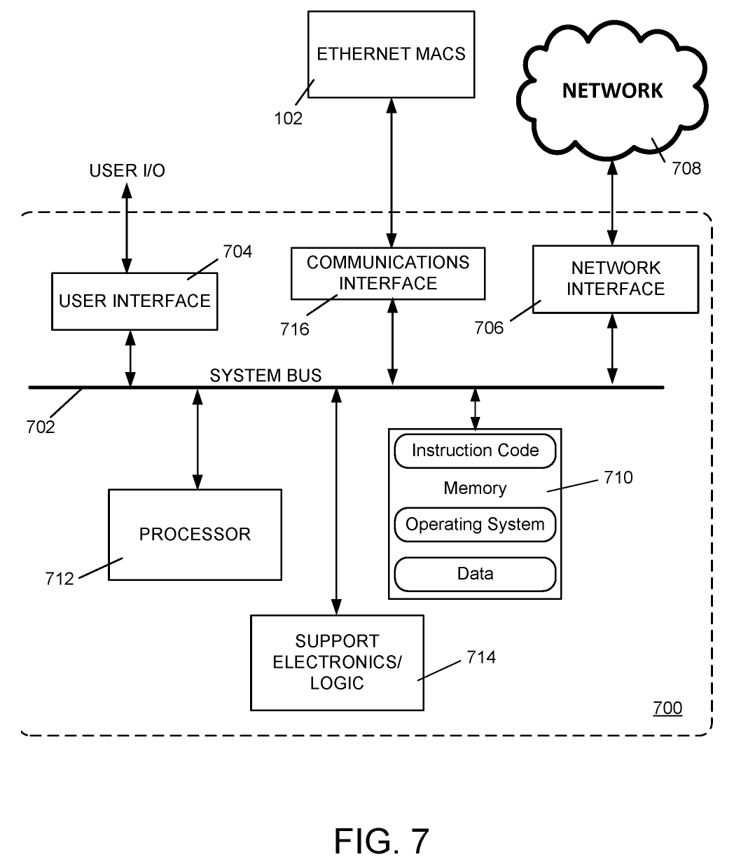

FIG. 7 is a diagram of an example internal structure of a processing system 700 that may be used to implement one or more of the embodiments herein. Each processing system 700 contains a system bus 702, where a bus is a set of hardware lines used for data transfer among the components of a computer or processing system. The system bus 702 is essentially a shared conduit that connects different components of a processing system (e.g., processor, disk storage, memory, input/output ports, network ports, etc.) that enables the transfer of information between the components.

Attached to the system bus 702 is a user I/O device interface 704 for connecting various input and output devices (e.g., keyboard, mouse, displays, printers, speakers, etc.) to the processing system 700. A network interface 706 allows the computer to connect to various other devices attached to a network 708. Memory 710 provides volatile and non-volatile storage for information such as computer software instructions used to implement one or more of the embodiments of the present invention described herein, for data generated internally and for data received from sources external to the processing system 700.

A central processor unit 712 is also attached to the system bus 702 and provides for the execution of computer instructions stored in memory 710. The system may also include support electronics/logic 714, and a communications interface 716. In this example embodiment, the communications interface 716 is shown in communication with the Ethernet MACs 102, although the communications interface 716 may be used to communicate with other components.

In one embodiment, the information stored in memory 710 may comprise a computer program product, such that the memory 710 may comprise a non-transitory computer-readable medium (e.g., a removable storage medium such as one or more DVD-ROM’s, CD-ROM’s, diskettes, tapes, etc.) that provides at least a portion of the software instructions for the invention system. The computer program product can be installed by any suitable software installation procedure, as is well known in the art. In another embodiment, at least a portion of the software instructions may also be downloaded over a cable communication and/or wireless connection.

It will be apparent that one or more embodiments described herein may be implemented in many different forms of software and hardware. Software code and/or specialized hardware used to implement embodiments described herein is not limiting of the embodiments of the invention described herein. Thus, the operation and behavior of embodiments are described without reference to specific software code and/or specialized hardware – it being understood that one would be able to design software and/or hardware to implement the embodiments based on the description herein.

Further, certain embodiments of the example embodiments described herein may be implemented as logic that performs one or more functions. This logic may be hardware-based, software-based, or a combination of hardware-based and software-based. Some or all of the logic may be stored on one or more tangible, non-transitory, computer-readable storage media and may include computer-executable instructions that may be executed by a controller or processor. The computer-executable instructions may include instructions that implement one or more embodiments of the invention. The tangible, non-transitory, computer-readable storage media may be volatile or non-volatile and may include, for example, flash memories, dynamic memories, removable disks, and non-removable disks.

While example embodiments have been particularly shown and described, it will be understood by those skilled in the art that various changes in form and details may be made therein without departing from the scope of the embodiments encompassed by the appended claims.

What is claimed is:

1. A method of reassembling a set of packet fragments, comprising:
receiving, with a hardware-based input processing handler, a plurality of packet fragments;
associating, with a hardware-based hash content addressable memory (CAM), two or more of the plurality of packet fragments as components of a complete packet;
excising, with a hardware-based reassembly engine, one or more headers from the two or more of the plurality of packet fragments to produce excised packet fragments; and
combining, with the hardware-based reassembly engine, the excised packet fragments to form a reassembled complete packet.

2. The method of claim 1, wherein the associating further comprises generating a current hash of one or more components of a packet fragment header and determining that a prior generated hash matches the current hash.

3. The method of claim 1, further comprising storing headers of the plurality of packet fragments and first fragment of the complete packet in a hardware-based header storage component.

4. The method of claim 1, further comprising determining a partial checksum for each packet fragment payload and storing the partial checksum in memory.

5. The method of claim 4, further comprising combining the partial checksums determined for each packet fragment payload to form a complete checksum that is appended to the complete packet payload.

6. The method of claim 1, further comprising forwarding to a software-based processing system, using a hardware-based metapacket formatter, two or more pointers to components of the complete packet.

7. A system for reassembling a set of packet fragments, comprising:
a hardware-based input processing handler that receives a plurality of packet fragments;
a hardware-based hash content addressable memory (CAM) that associates two or more of the plurality of packet fragments as components of a complete packet;
a hardware-based reassembly engine that excises one or more headers from the two or more of the plurality of packet fragments to produce excised packet fragments;
the hardware-based reassembly engine combines the excised packet fragments to form a reassembled complete packet.

8. The system of claim 7, wherein the hardware-based hash CAM further generates a current hash of one or more components of a packet fragment header and determines that a prior generated hash matches the current hash.

9. The system of claim 7, wherein a hardware-based header storage component stores headers of the plurality of packet fragments and first fragment of the complete packet.

10. The system of claim 7, wherein a partial checksum for each packet fragment payload is stored in memory.

11. The system of claim 10, wherein a fragment association state component combines the partial checksums determined for each packet fragment payload to form a complete checksum that is appended to the complete packet payload.

12. The system of claim 7, wherein a hardware-based metapacket formatter forwards two or more pointers to a software-based processing system, each of the two or more pointers designates a component of the complete packet.

13. The system of claim 7, wherein the hardware-based hash CAM generates and stores a CRC checksum for each stored key and searches the stored CRC checksums to determine if the CRC of an incoming key matches any of the stored CRC checksums.

14. The system of claim 7, wherein the reassembly engine further stitches together two or more pointers across packet fragments into a single list of scatter-gather blocks.

15. A non-transitory computer-readable medium with computer code instruction stored thereon, the computer code instructions, when executed by a processor, cause an apparatus to:
receive a plurality of packet fragments;
associate two or more of the plurality of packet fragments as components of a complete packet;
excise one or more headers from the two or more of the plurality of packet fragments to produce excised packet fragments;
combine the excised packet fragments to form a reassembled complete packet.

16. The non-transitory computer-readable medium of claim 15, wherein the computer code instructions further cause an apparatus to generate a current hash of one or more components of a packet fragment header and determines that a prior generated hash matches the current hash.

17. The non-transitory computer-readable medium of claim 15, wherein the computer code instructions further cause an apparatus to store headers of the plurality of packet fragments and first fragment of the complete packet.

18. The non-transitory computer-readable medium of claim 15, wherein the computer code instructions further cause an apparatus to store a partial checksum for each packet in memory.

19. The non-transitory computer-readable medium of claim 18, wherein the computer code instructions further cause an apparatus to combine the partial checksums determined for each packet fragment payload to form a complete checksum that is appended to the complete packet payload.

20. A system for reassembling a set of packet fragments, comprising:
means for receiving a plurality of packet fragments;
means for associating two or more of the plurality of packet fragments as components of a complete packet;
means for excising one or more headers from the two or more of the plurality of packet fragments to produce excised packet fragments; and
means for combining the excised packet fragments to form a reassembled complete packet.
